(19) United States
(12) Patent Application Publication
(10) Pub. No.: US 2004/0119736 A1
(43) Pub. Date: Jun. 24, 2004

(54) System and method for displaying events of network devices

(76) Inventors: Yi Chjen Chen, Tu-chen (TW); Jain-Chung Wang, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/641,937

(22) Filed: Aug. 15, 2003

(30) Foreign Application Priority Data
Dec. 20, 2002 (TW) 91136956

(51) Int. Cl. G09G 5/00

(52) U.S. Cl. 345/736

(57) ABSTRACT

A system and method for displaying events of a plurality of network devices (6) is provided. The system can remotely monitor a plurality of network devices via an administrative workstation (2) and display information on events thereon in time. Each networking devices includes an event managing module (65) which can automatically determine whether a current event needs displaying according to information on the event. The administrative workstation comprises an event obtaining module (23) and an event information page (25). The event obtaining module can obtain information on an event and a corresponding device name. The event information page displays events that need displaying. System administrator can predefine each event as a displaying event or a non-displaying event via an event setting module (22) of the administrative workstation.

### BACKGROUND OF THE INVENTION

1. Field of the Invention

The present invention relates to computer network administration systems and methods, and particularly to an event management system and method for network devices.

2. Background of the Invention

With the rapid development of networking technology in the late 1980s and in the 1990s, more and more sub-networks are being used in organizations. It is becoming increasingly important to monitor network activities in such organizations. With growing amounts of networking and mainframes in a network, it is becoming more difficult for professionals to effectively administer the network. Comprehensive standards and effective methods are needed for proper administration of the network. Presently, SNMP (simple network management protocol) is widely used. Nearly all network devices, such as switches, routers and PCs (personal computers), support this protocol. Further, each public terminal device installing an SNMP adapter, such as a printer or a fax coupled to a network, or a UPS (uninterrupted power supply), is connected by way of a node to build a LAN (local area network). Each LAN is connected together to build a WAN (wide area network), which is monitored by an administrative workstation remotely.

New configurations have emerged from recent developments in networking technology. For example, adding the support of HTTP (hypertext transfer protocol) to a SNMP adapter provides a Web/SNMP adapter. As a result, users can set and monitor network devices located in different places via a Web browser. Alternatively, setting and monitoring remote network devices can also be implemented by installing a proxy in network devices or computers connecting with the public terminal devices.

TW Published Patent No. 480,426 issued on Mar. 21, 2002 and entitled “Method for managing network devices, using web pages” is exemplary. The method disclosed by this patent is implemented in a networking environment, which comprises an administrative workstation and a plurality of network devices in a network. The administrative workstation communicates via HTTP with interfaces of web pages on all the network devices. The workstation computer comprises a database and a processing module for administration of networks. Using Web browser technology, the workstation computer can communicate with the network devices directly, and display information on statuses of all the network devices on the workstation computer for network administrators to monitor.

This kind of network may have large numbers of network devices, each comprising a plurality of software modules and a plurality of hardware modules. The number of events that need to be monitored by the administrative workstation are accordingly numerous. The method disclosed in said patent can display the information on events of all the network devices on web browsers, but this may include unimportant events. This makes the network administrators' tasks more cumbersome and difficult. In addition, large amounts of status information need to be transferred, great pressure is brought to bear on communication channels in the networking system. Furthermore, the amount of information needing storing is so large that it is difficult for the administrative workstation to store and backup information.

### SUMMARY OF THE INVENTION

Accordingly, an object of the present invention is to provide an event display system and method such that an administrative workstation only obtains relevant information on events that need displaying.

To achieve the above-mentioned object, an event display system comprises: an administrative workstation, a plurality of network devices, and a connection connecting the administrative workstation and the network devices. The system can remotely monitor the networking devices via the administrative workstation and display relevant information thereon in real time. Each networking device comprises an event managing module which can automatically determine whether a current event needs to be displayed. The administrative workstation comprises an event obtaining module and an event information page. The event obtaining module can obtain information on events by accessing a storage periodically. The event information page displays the obtained information on events. Network administrators can predefine each event as a displaying event or a non-displaying event via an event setting module of the administrative workstation.

Further, the present invention provides an event display method for remotely monitoring a plurality of network devices via an administrative workstation connected with the network devices by a connection, and for displaying information on events that need displaying in real time, wherein the method comprises the steps of: (a) registering events in an event register, and generating event register information correspondingly; (b) obtaining event register information and modifying display statuses of events; (c) storing the event register information in an event register of the corresponding network device; (d) after detecting an event, obtaining event register information by accessing event registers, and determining whether the event needs displaying; (e) storing the information on the event in a storage of the corresponding network device, if the event needs displaying; (f) the administrative workstation obtaining the information on the event and a corresponding device name, and displaying the information on the event and the device name on an event information page.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of infrastructure of an events display system in accordance with a first preferred embodiment of the present invention;

FIG. 2 schematically illustrates relationships among various of items of one network device in accordance with the first embodiment of the present invention;

FIG. 3 is a schematic diagram of an exemplary event information page of the event display system and method in accordance with the first preferred embodiment of the present invention;

FIG. 4 is a flowchart of operation of the administrative workstation in accordance with the first embodiment of the present invention;

FIG. 5 is a schematic diagram of infrastructure of an event display system in accordance with a second preferred embodiment of the present invention;

FIG. 6 is a flowchart of operation of the event display system in accordance with the second embodiment of the present invention; and

FIG. 7 is a schematic diagram of an exemplary event information page of the event display system and method in accordance with the second preferred embodiment of the present invention.

### DETAILED DESCRIPTION OF THE INVENTION

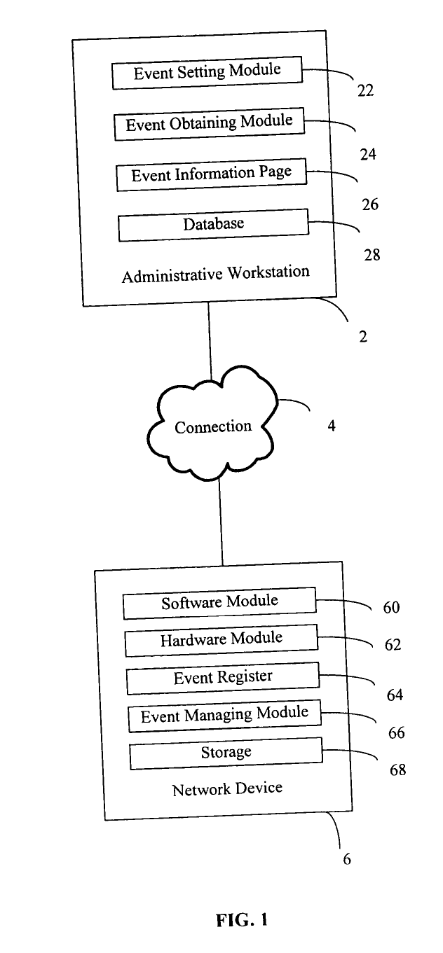

FIG. 1 is a schematic diagram of infrastructure of an event display system in accordance with a first preferred embodiment of the present invention. The events display system comprises an administrative workstation 2, a plurality of network devices 6 (only one shown), and a connection 4 connecting the administrative workstation 2 and the network devices 6. The administrative workstation 2 can transfer information via HTTP (Hypertext Transfer Protocol), obtain information on events, and display the information on the events on the network devices 6 in real time. In this way, network administrators can remotely monitor the network devices 6. The connection 4 may be the Internet or an intranet. The term “event” as used herein refers to pre-defined occurrences that can take place during implementation of the network devices 6. Such occurrences may, for example, include complete break down, software collision, hardware failure, and certain changes in basic settings that users of the network devices 6 program in.

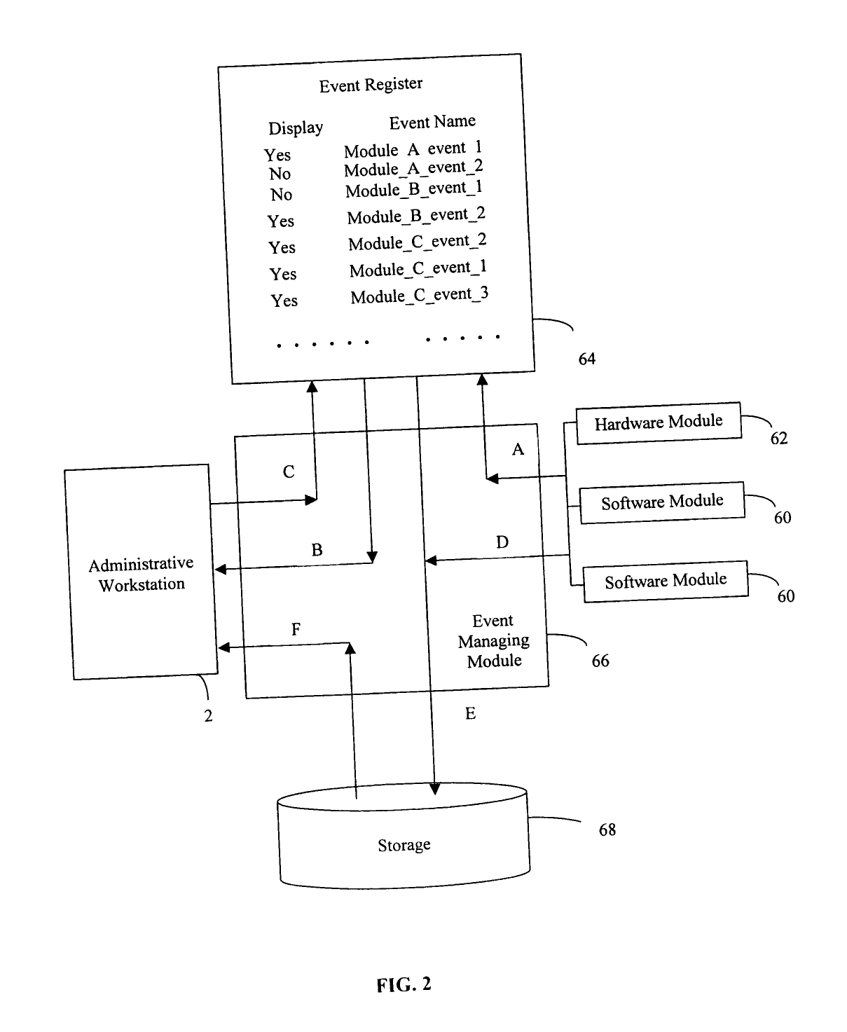

Each network device 6 may be a switch, a router, a server, a computer workstation, a printer or a fax coupled to a network, or a ULPS (Uninterrupted Power Supply). Communication software supporting HTTP is installed in each network device 6. Each network device 6 further comprises a plurality of software modules 60 (only shown one), a plurality of hardware modules 62 (only shown one), an event register 64, an event managing module 66, and a storage 68. The software modules 60 are various kinds of system software and application software known in the art and installed in the network devices 6. The hardware modules 62 are various kinds of hardware facilities known in the art. For example, when the network device 6 is a computer workstation, the hardware modules 62 may comprise a display, a microprocessor, a hard disk, and a mainboard. The event register 64 may be a database, for defining and storing event register information of the network device 6. The event managing module 66 is a kernel module, for dynamically monitoring implementation of the software modules 60 and the hardware modules 62, obtaining relevant information on events when the events occur, storing said information on events in the storage 68, and sending said information on events to the administrative workstation 2. The storage 68 is for storing information on events, and may be a database, an electrically erasable memory or a cache. Functions of the above-mentioned sub-modules 60, 62, 64, 66, 68 are further detailed in the following description in relation to FIG. 2.

The administrative workstation 2 generally comprises a computer device and corresponding communication software (not shown), the communication software supporting HTTP. In the first preferred embodiment of the present invention, the administrative workstation 2 further comprises an event setting module 22, an event obtaining module 24, an event information page 26 and a database 28. The event setting module 22 can obtain event register information from the event registers 64 of the network devices 6, and display the event register information on a register setting webpage (not shown). The register setting webpage is a user interface. The network administrator can set a display status of an event as “Yes” or “No” on the register setting webpage, based on actual needs of users. The event obtaining module 24 periodically accesses the information on events in the storage 68 of each network device 6. The event information page 26 is for displaying the obtained information on events. The database 28 is for storing the information on events obtained by the event obtaining module 24. Because the capacity of the storage 68 is limited, a maximum number of events likely to occur needs to be known, so that the storage 68 is not overloaded when the network devices 6 are accessed at regular intervals. In the first embodiment of the present invention, the capacity of the storage 68 is 1,000 items of event information, which can of course be adjusted to fulfill particular application circumstances.

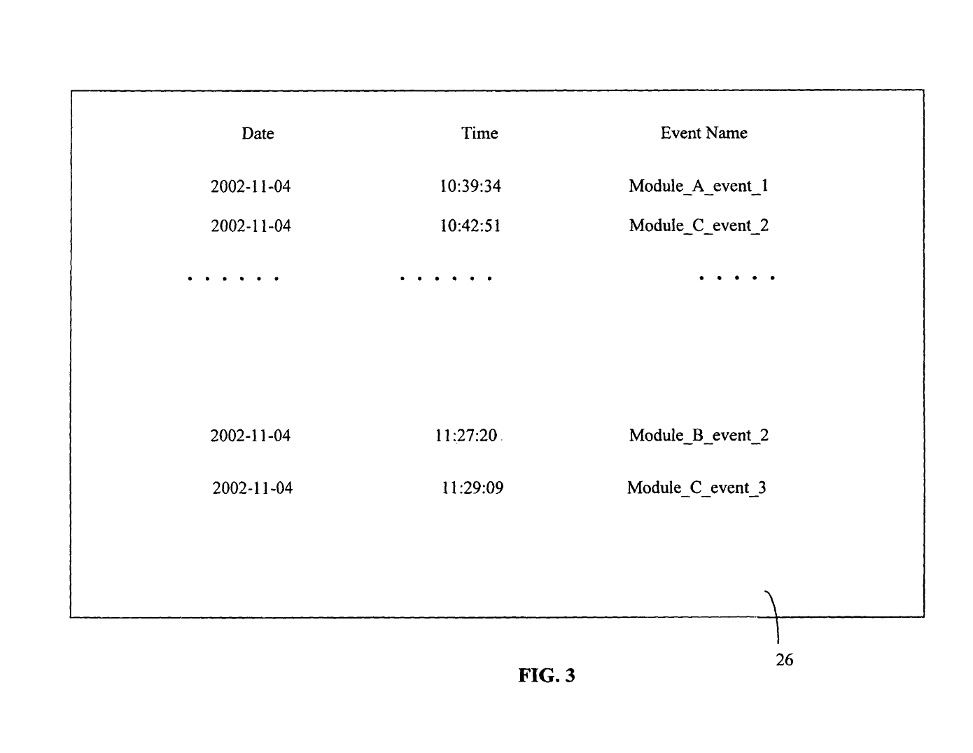

FIG. 2 schematically illustrates relationships among various of the items of one network devices 6 in accordance with the first preferred embodiment of the present invention. The relationships are respectively designated A through F, and are described in detail as follows. A: When the network device 6 is initialized by an administrator, the event managing module 66 registers events in the event register 64 for the software modules 60 and the hardware modules 62, and generates event register information for each event. Further, when a software module 60 (or a hardware module 62) is added to the network device 6, the event managing module 66 registers an event for the software module 60 (or the hardware module 62) in the event register 64, and generates corresponding event register information. Each event register is divided into two columns. One column called “Event Name” is for recording names of all events; and the other column called “Display” is for defining display statuses of information on events. The display status, predefined by the network administrator, may be “Yes” or “No” (see below) B: The administrative workstation 2 accesses the event register 64 of the network device 6, and displays event register information on the register setting webpage (not shown). The network administrator can modify the display status of each event. C: The event managing module 66 stores modified event register information in the event register 64 of the network device 6. D: After detecting an event, the event managing module 66 obtains the event register information by querying the event register 64, and determines whether the event needs to be displayed according to the display status of the event. E: If the display status of the event is “Yes” (i.e. the event needs to be displayed), the event managing module 66 stores information on the event in the storage 68. Exemplary information on events is illustrated in FIG. 3. The information is divided into three columns designated “Date,” “Time” and “Event Name,” which respectively correspond to the date and the time when an event occurs, and a pre-defined name of the event. Each item of information on events has a corresponding entry in an index in the storage 68. The index records addresses of a head item and an end item. In the first preferred embodiment of the present invention, the range of addresses is from 0 to 999, because the capacity of the storage 68 is 1,000 items of event information. The head item is the first item of information on an event, and the end item means a first empty item in the index. A current item of information on an event is stored in the end item address. Then 1 is added to the end item address to obtain a new current item address. When the end item address overruns the index's capacity of 999, the end item address changes to 0. That is, the period of the end item address is 1,000. When the end item address reaches the head item address, the latter moves ahead. The period of the head index address is also 1,000. F: The administrative workstation 2 accesses the storage 68 via the event managing module 66, obtains information on a detected event, stores the information on the event in the database 28, and displays the information on the event on the event information page 26.

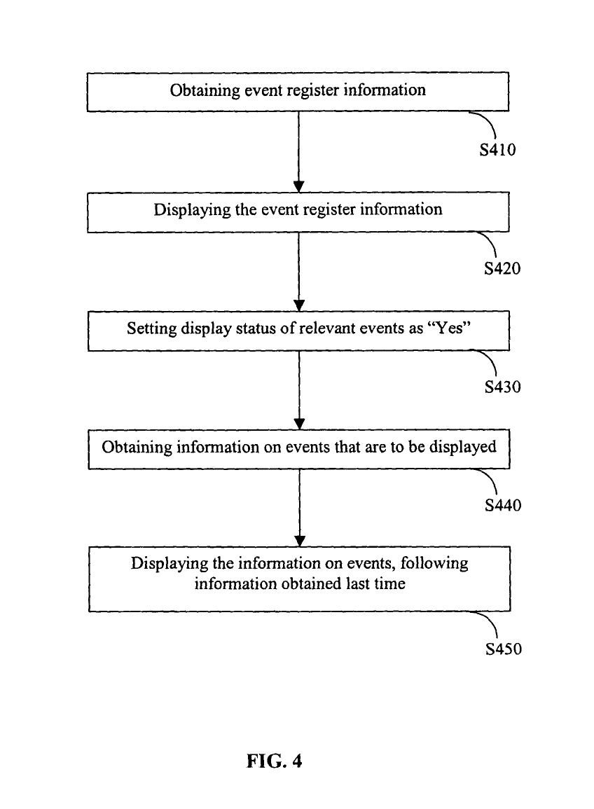

FIG. 4 is a flowchart of operation of the administrative workstation 2 in accordance with the first preferred embodiment of the present invention. In step S410, the event setting module 22 of the administrative workstation 2 accesses the event register 64 of each network device 6 via the connection 4 and obtains event register information. In step S420, the event setting module 22 displays said event register information on the register setting webpage. In step S430, the network administrator clicks on selected events in the event register information according to need, modifies the display statuses of the selected events, sends a result of modification to each relevant network device 6, and updates each relevant event register 64 accordingly. In step S440, the event obtaining module 24 periodically accesses the storage 68 of each network device 6 and obtains information on events that have not been displayed. In step S450, the information on events is displayed on the event information page 26, following information on events already displayed.

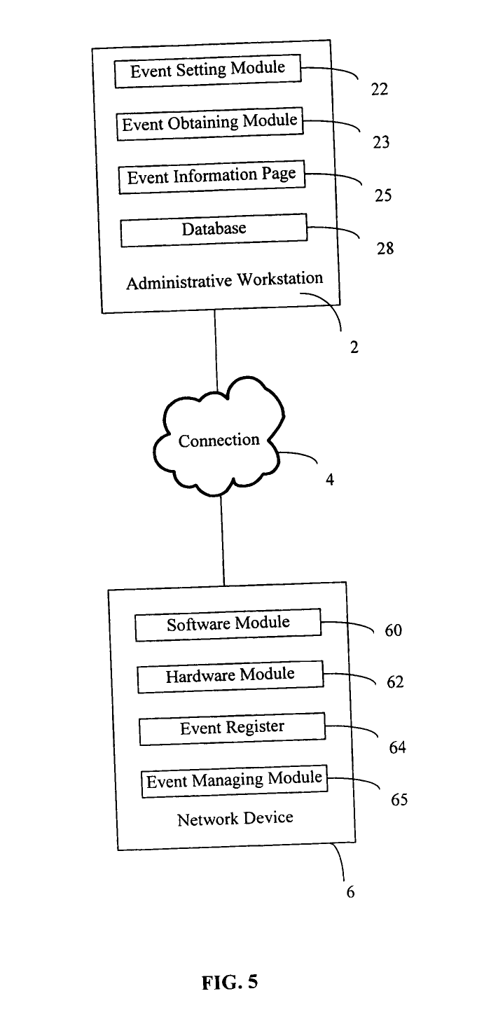

FIG. 5 is a schematic diagram of infrastructure of an event display system in accordance with a second preferred embodiment of the present invention. The event display system comprises a plurality of network devices 6 (only one shown), and an administrative workstation 2 connected with the network devices 6 via a connection 4. When events occur at the network devices 6, the administrative workstation 2 obtains information on the events, and displays the information on the events in real time. In this way, a network administrator can remotely monitors the network devices 6.

Each network device 6 may be a switch, a router, a server, a computer workstation, a printer or a fax coupled to a network, or a UPS (Uninterrupted Power Supply). Communication software supporting HTTP is installed in each network devices 6. Each network device 6 further comprises a plurality of software modules 60 (only shown one), a plurality of hardware modules 62 (only shown one), an event register 64, and an event managing module 65. The software modules 60 are various kinds of system software and application software known in the art and installed in the network device 6. The hardware modules 62 are various kinds of hardware facilities known in the art. For example, when the network device 6 is a computer workstation, the hardware modules 62 may comprise a display, a microprocessor, a hard disk, and a mainboard. The event register 64 may be a database, for defining and storing event register information of the network device 6. The event register information is divided into two columns. One column called “Event Name” is for recording names of all events; and the other column called “Display” is for defining display statuses of information on events. The display status, predefined by the network administrator, may be “Yes” or “No” (see below). The event managing module 65 is a kernel module, for dynamically monitoring implementation of the software modules 60 and the hardware modules 62, determining whether an event needs displaying, displaying information on the event if the event needs displaying, and sending the information on the event to the administrative workstation 2.

The administrative workstation 2 generally comprises a computer device and corresponding communication software (not shown) supporting HTTP. The administrative workstation 2 further comprises an event setting module 22, an event obtaining module 23, an event information page 25, and a database 28. The event setting module 22 can obtain event register information from the event registers 64 of the network devices 6, and display the event register information on a register setting webpage (not shown). The register setting webpage is a user interface. The network administrator can set a display status of an event as “Yes” or “No” on the register setting webpage, based on actual needs of users. The event obtaining module 23 is for receiving information on events sent by the event managing modules 66 of the network devices 6, and receiving corresponding device names. The device names are pre-defined names of the network devices 6 at which the events occurred. The event information page 25 is for displaying the obtained information on events. The database 28 is for storing the obtained information on events.

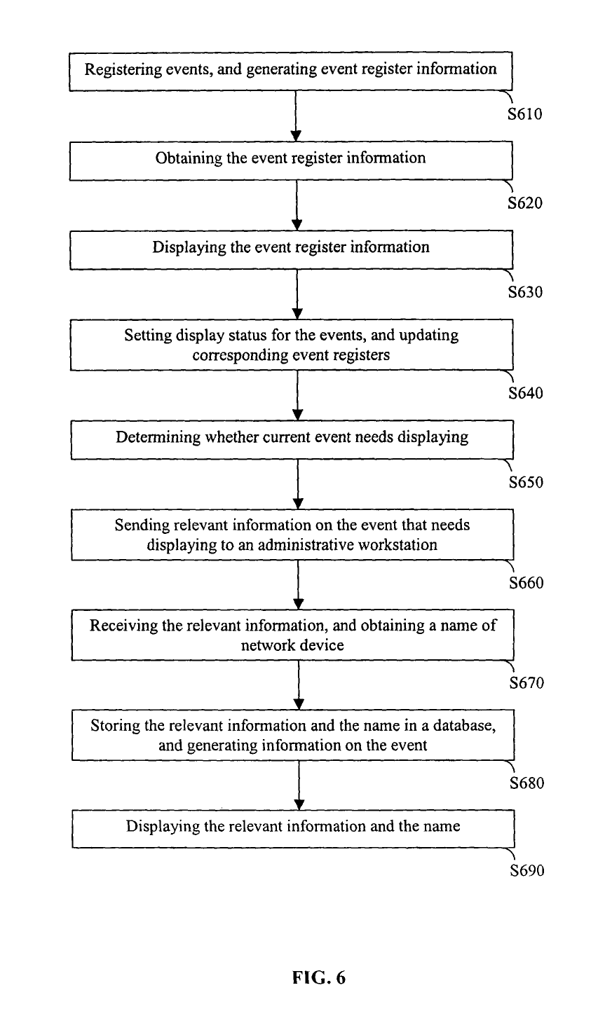

FIG. 6 is a flowchart of operation of the event display system in accordance with the second preferred embodiment of the present invention. In step S610, the network devices 6 are initialized by a network administrator. For each network device 6, the event managing module 65 registers events in the event register 64 for all the software modules 60 and hardware modules 62, and generates event register information for each event. Further, when a software module 60 (or a hardware module 62) is added to the network device 6, the event managing module 66 registers an event for the software module 60 (or the hardware module 62) in the event register 64, and generates corresponding event register information. In step S620, the event setting module 22 of the administrative workstation 2 accesses the event register 64 of each network device 6 via the connection 4, and obtains the event register information. In step S630, the event setting module 22 displays the obtained event register information on the register setting webpage (not shown). In step S640, the network administrator clicks on selected events in the event register information according to need, modifies the display statuses of the selected events, sends a result of modification to each relevant network device 6, and updates each relevant event register 64 accordingly. In step S650, after detecting an event, the event managing module 65 obtains event register information by querying the corresponding event register 64, and determines whether the event needs displaying according to the display status of the event. If the display status of the event is “Yes” (i.e. the event needs to be displayed), in step S660, the event managing module 65 sends the information on the event to the administrative workstation 2. The information on the event comprises a date and a time of occurrence of the event, and a name of the event. In step S670, the event obtaining module 23 receives the information on the event sent by the event managing module 65, and obtains a device name of corresponding network device 6. In step S680, the event obtaining module 23 stores the information on the event and the device name in the database 28, and generates an item of event information. The item of event information comprises four elements classified under “Date,” “Time,” “Event Name” and “Device Name,” being respectively the date and the time when the event occurs, the event name, and the device name. In step S690, the event obtaining module 23 displays the event information on the event information page 25, following information on events already displayed.

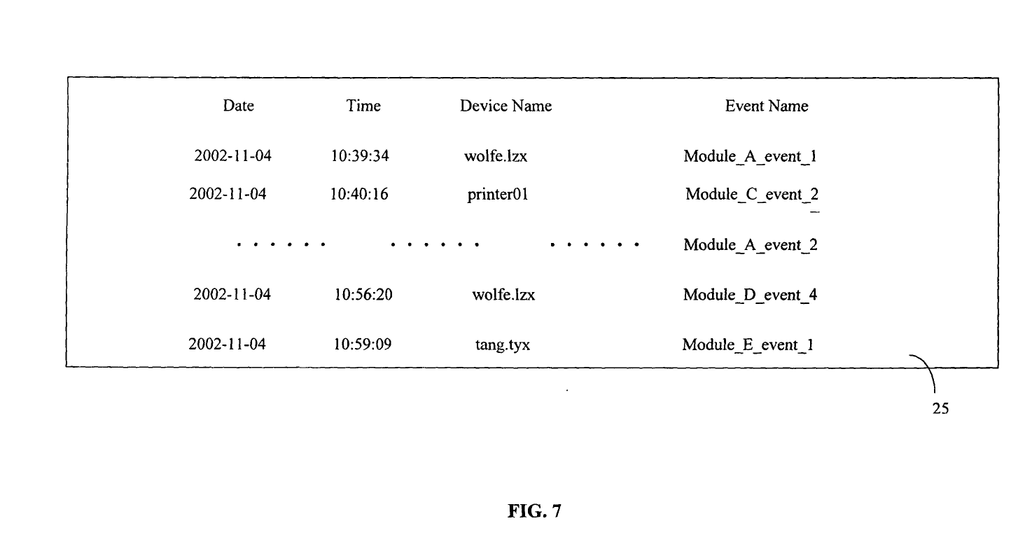

FIG. 7 is a schematic illustration of an exemplary event information page 25 of the event display system and method in accordance with the second preferred embodiment of the present invention. The event information page 25 is divided into four columns designated “Date,” “Time,” “Device Name,” and “Event Name,” which respectively correspond to the date and the time when an event occurs, the name of the device, and the name of the event.

In general, the event display system and method of the present invention may take forms other than what is described above. While preferred embodiments for carrying out the present invention have been described in detail, those familiar with the art to which the invention relates will recognize various alternative designs and embodiments for practicing the present invention. These alternative embodiments are within the scope of the present invention. The scope of the present invention is defined by the claims appended hereto and allowable equivalents thereof.

What is claimed is:

1. An event display system comprising:
a plurality of network devices, each of the network devices comprising a first module for determining whether events of the network device need displaying; and
an administrative workstation connected with the network devices via a connection, the administrative workstation comprising:
a second module for obtaining information on events and device names of the network devices; and
a user interface for displaying the information on events and the device names.

2. The system according to claim 1, wherein each of the network device further comprises a first database for storing event register information for the network device.

3. The system according to claim 2, wherein the event register information comprises:
a column for defining whether an event needs displaying; and
a column for recording an event name.

4. The system according to claim 1, wherein the administrative workstation further comprises a third module for obtaining the event register information from the first database.

5. The system according to claim 1, wherein each of the network device further comprises a second database for storing the information on events that need displaying.

6. The system according to claim 5, wherein the information on events comprises the dates and times when the events happen, and the event names.

7. The system according to claim 1, wherein the administrative workstation further comprises a third database for storing the information on events that need displaying.

8. The system according to claim 7, wherein the information on events comprises the dates and times when the events happen, and the event names.

9. An event display system comprising:
a plurality of network devices, each of the network devices comprising:
a first database for storing event register information for the network device;
a second database for storing information on events that need displaying; and
a first module for determining whether an event needs displaying based on the event register information of the event, and for storing the information on events that need displaying in the second database; and
an administrative workstation connected with the network devices via a connection, the administrative workstation comprising:
a second module for obtaining the information on events from the second databases of the network devices and device names of the network devices; and
a first user interface for displaying the information on events and the device names.

10. The system according to claim 9, wherein the event register information comprises:
a column for defining whether an event needs displaying; and
a column for recording an event name.

11. The system according to claim 9, wherein the administrative workstation further comprises a third module for obtaining the event register information from the first database of the network devices.

12. The system according to claim 9, wherein said information on events comprises the dates and times when the events happen, and event names.

13. An event display method for remotely monitoring a plurality of network devices via an administrative workstation connected with the network devices by a connection, and for displaying information on events that need displaying in real time, the method comprising the steps of:
(a) determining whether an event needs displaying;
(b) obtaining information on the event and a corresponding device name; and
(c) displaying the information on the event and the device name on a user interface.

14. The method according to claim 13, further comprising the step of:
(d) for each of the network devices, registering events in an event register, and generating event register information correspondingly.

15. The method according to claim 14, further comprising the step of:
(e) obtaining event register information and modifying display statuses of events.

16. The method according to claim 13, wherein step (a) further comprises the step of:
storing the information on the event in a storage of the corresponding network device, if the event needs displaying.

17. The method according to claim 16, wherein step (b) further comprises the step of:
obtaining the information on the events by periodically accessing the storage.

18. The method according to claim 13, wherein step (a) further comprises the steps of:
sending the information on the event to the administrative workstation;
obtaining information on the corresponding device name; and
storing the information on the event and the corresponding device name in a database of the administrative workstation.

19. The method according to claim 13, wherein the step (a) is implemented via an event register and the step (b) is implemented via an event managing module communicating with the event register.
